(19) United States
(12) Patent Application Publication
(10) Pub. No.: US 2006/0279826 A1
(43) Pub. Date: Dec. 14, 2006

(54) MULTI-LASER SCANNING UNIT AND AN IMAGE FORMING APPARATUS

(75) Inventor: Wook-bae Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/449,630

(22) Filed: Jun. 9, 2006

(30) Foreign Application Priority Data
Jun. 11, 2005 (KR) 10-2005-0050141

(51) Int. Cl. G02B 26/08

(52) U.S. Cl. 359/204; 359/201; 347/243

(57) ABSTRACT

A multi-beam deflector and a multi-laser scanning unit including the same are provided. The multi-beam deflector deflects N incident light beams which are spaced apart from each other by a beam pitch. The N incident light beams are deflected onto N photoreceptors which are spaced apart from each other. The beam deflector includes a deflecting reflection mirror that includes N deflecting reflection surfaces and a driving body. The N deflecting reflection surfaces correspond to the photoreceptors with a predetermined angle between each of the reflection surfaces, and respectively scan the N incident light beams to the corresponding photoreceptors. The driving body vibrates the deflecting reflection mirror about a rotation axis. The number of optical components is reduced and the apparatus is simpler, alignment of the optical components is simpler, and the degree of freedom of optical components is improved.

### CROSS-REFERENCE TO RELATED PATENT APPLICATION

This application claims the benefit under 35 U.S.C. § 119(a) of Korean Patent Application No. 10-2005-0050141, filed on Jun. 11, 2005, in the Korean Intellectual Property Office, the entire disclosure of which is hereby incorporated by reference.

### BACKGROUND OF THE INVENTION

1. Field of the Invention

The present invention relates to a multi-laser scanning unit and an image forming apparatus having the same. More particularly, the present invention relates to a multi-laser scanning unit that produces a multi-color image by scanning light beams emitted from a plurality of light sources onto different photoreceptors and an image forming apparatus having the same.

2. Description of the Related Art

In general, a laser scanning unit (LSU), which is employed in laser printers, digital photocopiers, bar code readers, facsimiles, and the like, forms a latent image on a photoreceptor by scanning a laser beam with a beam deflector in a main scanning direction and rotating the photoreceptor in a sub-scanning direction. To produce a multi-color image in, for example, a color laser printer, a tandem image forming apparatus that includes a plurality of photoreceptors corresponding to each desired color is typically used.

FIG. 1 is a cross-sectional view of an image forming apparatus disclosed in Japanese Patent Publication No. P2004-255726, which is hereby incorporated by reference in its entirety. Referring to FIG. 1, the image forming apparatus includes photoreceptors (not shown) corresponding to each color component—for example, yellow, magenta, cyan, and black—an optical scanning device 1 which distributes and scans a beam onto a photoreceptor, and reflection mirrors 2 which guide light beams L_{Y}, L_{M}, L_{C}, and L_{K} onto the corresponding photoreceptors. The light scanning device 1 includes a micro mirror 5 which rotates around a first axis AX₁ and a second axis AX₂ which are orthogonal to each other. Thus, the micro mirror has two degrees of freedom to guide incident light in the main scanning and sub-scanning directions. The micro mirror 5 vibrates about the first axis AX₁ to scan a light beam in the main scanning direction and forms a latent image on one of the photoreceptors. The optical scanning device 1 scans light beams onto the photoreceptors, which are separated in the sub-scanning direction, by vibrating about the second axis AX₂ and selecting the photoreceptor to which a light beam is to be scanned. The optical path of the light beam scanned by the light scanning device 1 is switched, passing through a different set of the scanning lenses 4 and reflection mirrors 2, and light is concentrated on the selected photoreceptor to form a light spot by f-θ lenses 3Y, 3M, 3C, and 3K.

The above described light scanning device 1 guides a single incident beam in a main scanning direction and in a sub-scanning direction, and thus a proper sub-scanning speed as fast as, or even faster than, the main scanning speed in the sub-scanning direction is required. Also, the focusing position of light spots needs to be controlled precisely to produce high fidelity color and sharp images.

FIGS. 2A and 2B illustrate a multi-stage polygonal mirror 8 disclosed in Japanese Patent Publication No. P2002-174791, which is hereby incorporated by reference in its entirety. The multi-stage polygonal mirror 8 includes a plurality of reflection surfaces 8a along its external surface, and rotates around a rotational axis to scan a plurality of light beams to a plurality of photoreceptors at the same time. The reflection surfaces of the polygonal mirror 8 include a plurality of surfaces divided along the circumference C′ and the axis AX. The reflection surfaces 8a of the polygonal mirror 8 may not be identical, however, which degrades image quality. Also, its axis must be precisely aligned, and its manufacturing costs are high.

Accordingly, there is a continuing need for an improved laser scanning unit for a tandem image forming apparatus.

### SUMMARY OF THE INVENTION

An aspect of the present invention is to address at least the above problems and/or disadvantages and to provide at least the advantages described below. Accordingly, an aspect of the present invention is to provide a multi-beam deflector and a multi-laser scanning unit that is formed of a reduced number of optical components and is optimized for reducing the size of the apparatus having the same.

Another aspect of the present invention is to provide a multi-beam deflector and a multi-beam scanning unit having the same in which the positioning of components is simple, manufacturing costs are low, and a degree of freedom for alignment is improved.

According to an aspect of the present invention, a laser scanning device comprises first and second scanning focusing optical systems which each scan N light beams in a main scanning direction onto N photoreceptors proceeding in a sub-scanning direction to form a latent image. Each of the scanning focusing optical systems has a light source unit radiating N light beams substantially parallel to each other, and the light beams are spaced apart from each other by a beam pitch. A multi-beam deflector has a deflecting reflection mirror comprising N deflecting reflection surfaces corresponding to the N photoreceptors with an angle between the deflecting reflection surfaces. The deflecting reflection surfaces scan the light beams from the light source unit to the corresponding photoreceptors, and a driving body vibrates the deflecting reflection mirror about a rotation axis. At least one focusing optical unit focuses the light beams scanned from the multi-beam deflector onto each of the photoreceptors. The first scanning focusing optical system and the second scanning focusing optical system are arranged substantially parallel to each other along a sub-scanning direction.

The driving body may comprise a driving conductive pattern for forming an induced magnetic field around the deflecting reflecting mirror, and a permanent magnet for providing driving power to the deflecting reflection mirror by interacting with the induced magnetic field.

The at least one focusing optical unit may comprise scanning optical lenses for correcting light beams scanned by the multi-beam deflector with different magnifications along the main scanning direction and for focusing the beams on the corresponding photoreceptors, and reflection mirrors disposed along the light paths exiting the scanning optical lenses for guiding the light beams to the corresponding photoreceptors.

The first scanning focusing optical system and the second scanning focusing optical system may be spaced apart from each other along the sub-scanning direction.

Portions of the first scanning focusing optical system and the second scanning focusing optical system may overlap in the sub-scanning direction.

The photoreceptors may be spaced apart from each other along the sub-scanning direction.

According to another aspect of the present invention, a multi-laser scanning unit includes a first scanning focusing optical system and a second scanning focusing optical system which each form latent images by scanning two light beams in a main scanning direction onto first and second photoreceptors proceeding in a sub-scanning direction. Each of the scanning focusing optical system includes a light source unit emitting two different light beams substantially parallel to each other, the light beams being spaced apart from each other by a beam pitch, and a multi-beam deflector. The multi-beam deflector comprises a deflecting reflection mirror and a driving body. The deflecting reflection mirror comprises first and second deflecting reflection surfaces corresponding to the first and second photoreceptors. The first and second deflecting surface are angled with respect to one another and scan the light beams from the light source unit onto the corresponding photoreceptors. The driving body vibrates the deflecting reflection mirror about a rotation axis. A scanning optical lens corrects each light beam scanned from the multi-beam deflector with different magnifications in a main scanning direction and focuses the light beam on each photoreceptor. A reflection mirror is disposed in the exit path of the scanning optical lens, and the reflection mirror guides the light beams onto each of the photoreceptors. The first scanning focusing optical system and the second scanning focusing optical system are arranged substantially parallel to each other along a sub-scanning direction.

The first deflecting reflection surface and the second deflecting reflection surface may be inclined symmetrically on the installation surface of the driving body.

The light source unit may face the deflecting reflection mirror so that the light beams are incident upon a front surface of the deflecting reflection mirror.

The first deflecting reflection surface may be substantially parallel with respect to the surface of the driving body and the second deflecting reflection surface may be inclined with respect to the surface of the driving body.

The second deflecting reflection surface may form an acute angle with respect to the surface of the driving body.

The light source unit may face the deflecting reflection mirror at an angle with respect to the normal of the surface of the driving body.

According to yet another aspect of the present invention, a multi-laser scanning unit includes a first scanning focusing optical system and a second scanning focusing optical system which each form latent images by scanning N light beams in a main scanning direction onto N photoreceptors spaced along a sub-scanning direction. Each of the scanning focusing optical system comprises a light source unit, a multi-beam deflector, and at least one focusing optical unit. The light source unit radiates N light beams substantially parallel to each other, and the light beams are spaced apart from each other by a beam pitch. The multi-beam deflector comprises a deflecting reflection mirror and a driving body. The deflecting reflection mirror has N deflecting reflection surfaces corresponding to the N photoreceptors. The N deflecting reflection surfaces form an angle with respect to each other, and the deflecting reflection surfaces scan the light beams from the light source unit to the corresponding photoreceptors. The driving body vibrates the deflecting reflection mirror about a rotation axis. The at least one focusing optical unit focuses the light beams scanned from the multi-beam deflector. The first scanning focusing optical system and the second scanning focusing optical system are arranged at the same level along the sub-scanning direction.

The photoreceptors may be spaced apart from each other along the sub-scanning direction.

According to still another aspect of the present invention, a multi-laser scanning unit includes a first scanning focusing optical system and a second scanning focusing optical system which form a latent image by scanning two different light beams in a main scanning direction onto two different photoreceptors proceeding in a sub-scanning direction. Each scanning focusing optical system comprises a light source unit, a vibrating multi-beam deflector, scanning optical lenses, and reflection mirrors. The light source unit includes two different light sources that radiate two different light beams substantially parallel to each other. The light beams are spaced apart from each other by a beam pitch. The vibrating multi-beam deflector comprises a deflecting reflection mirror and a driving body. The deflecting reflection mirror includes a first deflecting reflection surface and a second deflecting reflection surface that correspond to each of the photoreceptors. The first and second deflecting reflection surfaces are angled with respect to each other. The driving body vibrates the deflecting reflection mirror about a rotation axis. The scanning optical lenses correct each light beam scanned from the multi-beam deflector with different magnifications along the main scanning direction and focus the light beams on each photoreceptor. The reflection mirrors are placed in the exit path of the scanning optical lens and guide light onto each photoreceptor. The first scanning focusing optical system and the second scanning focusing optical system are placed on an equal level along a sub-scanning direction.

According to another aspect of the present invention, an image forming apparatus comprises a multi-laser scanning unit and a developing unit. The multi-laser scanning unit comprises first and second scanning focusing optical systems which each scan N light beams in a main scanning direction onto N photoreceptors proceeding in a sub-scanning direction to form a latent image. The first and second scanning focusing optical system are arranged substantially parallel along a sub-scanning direction. Each of the scanning focusing optical systems comprises a light source unit radiating the N light beams substantially parallel to each other, the light beams being spaced apart from each other by a beam pitch, a multi-beam deflector comprising a deflecting reflection mirror having N deflecting reflection surfaces corresponding to the N photoreceptors with an angle between the deflecting reflection surfaces, the deflecting reflection surfaces scanning the light beams from the light source unit to the corresponding photoreceptors, and a driving body that vibrates the deflecting reflection mirror about a rotation axis, and at least one focusing optical unit for focusing the light beams scanned from the multi-beam deflector onto each of the photoreceptors. The developing unit develops the latent images formed on the photoreceptors into a visible image on a printing medium.

The first scanning focusing optical system and the second scanning focusing optical system may be spaced apart from each other along the sub-scanning direction.

Portions of the first scanning focusing optical system and the second scanning focusing optical system may overlap in the sub-scanning direction.

According to another aspect of the present invention, an image forming apparatus with a multi-laser scanning unit comprises a first scanning focusing optical system and a second scanning focusing optical system which each form latent images by scanning two light beams in a main scanning direction onto first and second photoreceptors proceeding in a sub-scanning direction. Each of the scanning focusing optical systems includes a light source unit emitting two different light beams substantially parallel to each other, the light beams being spaced apart from each other by a beam pitch, and a multi-beam deflector. The multi-beam deflector comprises a deflecting reflection mirror and a driving body. The deflecting reflection mirror comprises first and second deflecting reflection surfaces corresponding to the first and second photoreceptors. The first and second deflecting surface are angled with respect to one another and scan the light beams from the light source unit onto the corresponding photoreceptors. The driving body vibrates the deflecting reflection mirror about a rotation axis. A scanning optical lens corrects each light beam scanned from the multi-beam deflector with different magnifications in a main scanning direction and focuses the light beam on each photoreceptor. A reflection mirror is disposed in the exit path of the scanning optical lens, and the reflection mirror guides the light beams onto each of the photoreceptors. The first scanning focusing optical system and the second scanning focusing optical system are arranged substantially parallel to each other along a sub-scanning direction.

According to another aspect of the present invention, an image forming apparatus includes a multi-laser scanning unit including a first scanning focusing optical system and a second scanning focusing optical system which each form latent images by scanning N light beams in a main scanning direction onto N photoreceptors spaced along a sub-scanning direction. Each of the scanning focusing optical system comprises a light source unit, a multi-beam deflector, and at least one focusing optical unit. The light source unit radiates N light beams substantially parallel to each other, and the light beams are spaced apart from each other by a beam pitch. The multi-beam deflector comprises a deflecting reflection mirror and a driving body. The deflecting reflection mirror has N deflecting reflection surfaces corresponding to the N photoreceptors. The N deflecting reflection surfaces form an angle with respect to each other, and the deflecting reflection surfaces scan the light beams from the light source unit to the corresponding photoreceptors. The driving body vibrates the deflecting reflection mirror about a rotation axis. The at least one focusing optical unit focuses the light beams scanned from the multi-beam deflector. The first scanning focusing optical system and the second scanning focusing optical system are arranged at the same level along the sub-scanning direction.

The photoreceptors, to which light beams are scanned by one of the first scanning focusing optical system or the second scanning focusing optical system, may be separated from each other along a sub-scanning direction.

According to still aspect of the present invention, an image forming apparatus with a multi-laser scanning unit includes a first scanning focusing optical system and a second scanning focusing optical system which form a latent image by scanning two different light beams in a main scanning direction onto two different photoreceptors proceeding in a sub-scanning direction. Each scanning focusing optical system comprises a light source unit, a vibrating multi-beam deflector, scanning optical lenses, and reflection mirrors. The light source unit includes two different light sources that radiate two different light beams substantially parallel to each other. The light beams are spaced apart from each other by a beam pitch. The vibrating multi-beam deflector comprises a deflecting reflection mirror and a driving body. The deflecting reflection mirror includes a first deflecting reflection surface and a second deflecting reflection surface that correspond to each of the photoreceptors. The first and second deflecting reflection surfaces are angled with respect to each other. The driving body vibrates the deflecting reflection mirror about a rotation axis. The scanning optical lenses correct each light beam scanned from the multi-beam deflector with different magnifications along the main scanning direction and focus the light beams on each photoreceptor. The reflection mirrors are placed in the exit path of the scanning optical lens and guide light onto each photoreceptor. The first scanning focusing optical system and the second scanning focusing optical system are placed on an equal level along a sub-scanning direction.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a cross-sectional view of an image forming apparatus disclosed in Japanese Patent Publication No. P2004-255726;

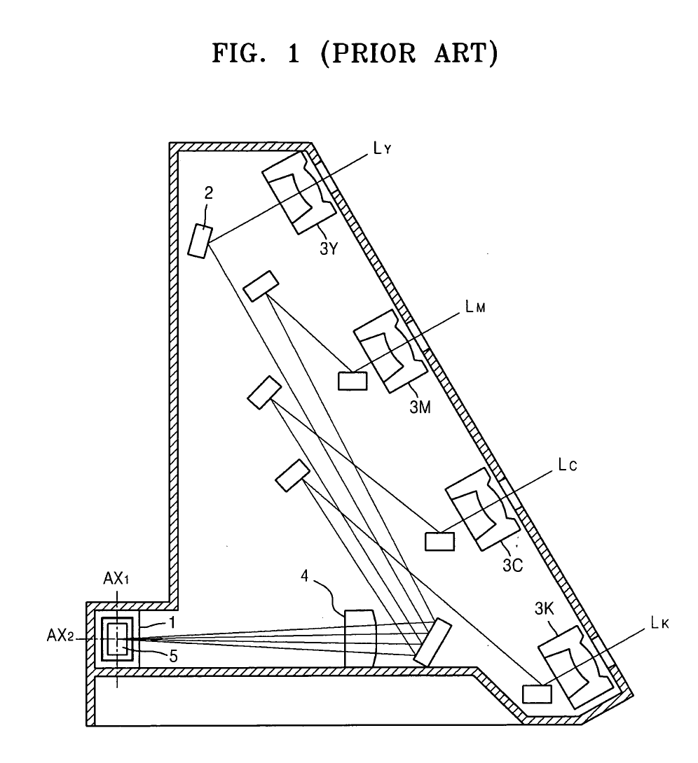

FIGS. 2A and 2B are side and plan views respectively of a multiple end polygonal mirror disclosed in Japanese Patent Publication No. P2002-174791;

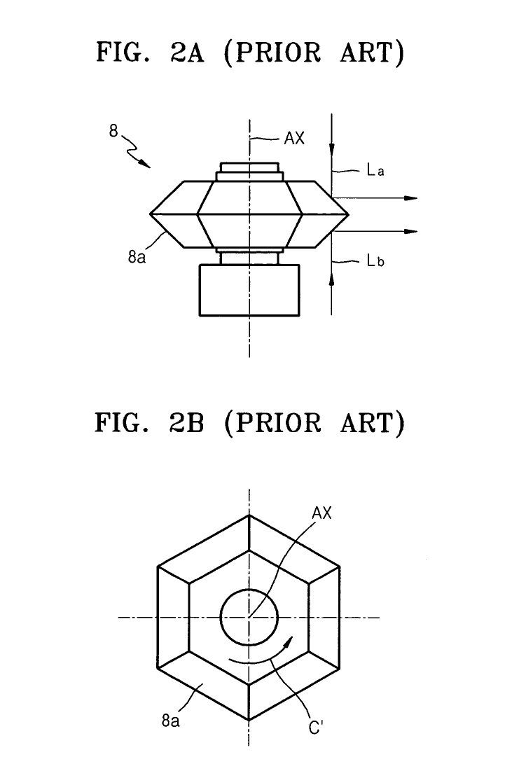

FIG. 3 is a perspective view of a multi-beam deflector according to a first exemplary embodiment of the present invention;

FIG. 4 is a perspective view of multi-beam deflector according to a second exemplary embodiment of the present invention;

FIG. 5 is a perspective view of a multi-laser scanning unit according to a third exemplary embodiment of the present invention;

FIG. 6 is a side view of the multi-laser scanning unit shown in FIG. 5;

FIG. 7 is a side view of a multi-laser scanning unit according to a fourth exemplary embodiment of the present invention;

FIG. 8 is a perspective view of a multi-laser scanning unit according to a fifth exemplary embodiment of the present invention;

FIG. 9 is a side view of the multi-laser scanning unit shown in FIG. 8;

FIG. 10 is a side view of a multi-laser scanning unit according to a sixth exemplary embodiment of the present invention; and

FIG. 11 is a sectional view of an image forming apparatus according to an exemplary embodiment of the present invention.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

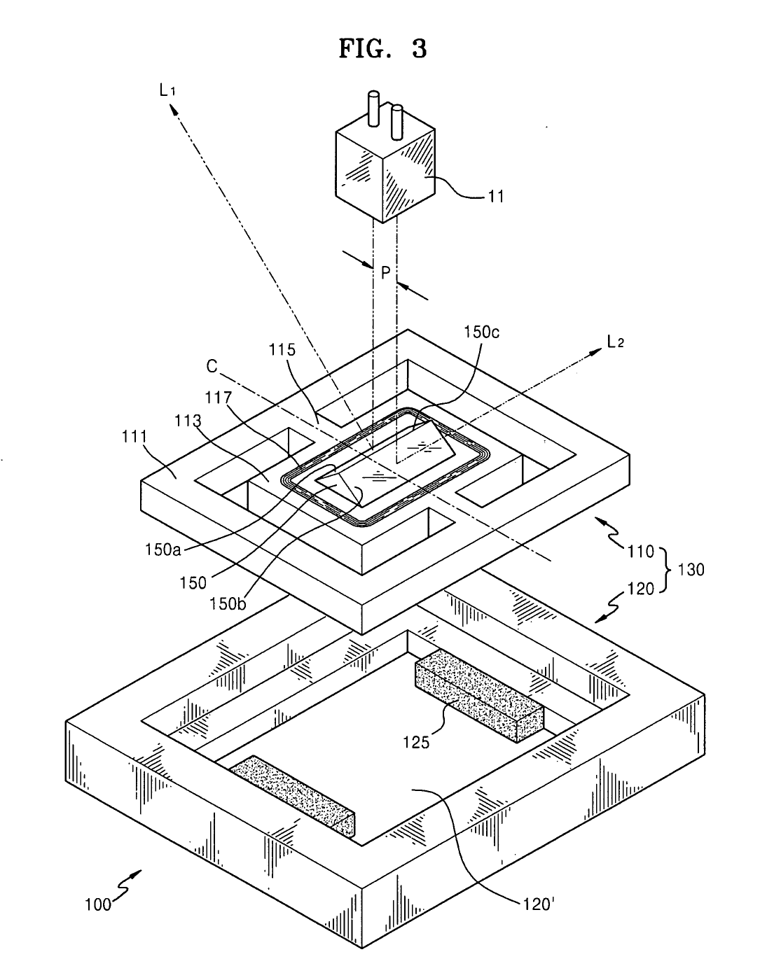

FIG. 3 illustrates a beam deflector 100 according to a first exemplary embodiment of the present invention. The beam deflector 100 includes a deflecting reflection mirror 150 and a driving body 130. The deflecting reflection mirror includes deflecting reflection surfaces 150a and 150b and the driving body 130 vibrates the deflecting reflection mirror 150 with a predetermined frequency. The driving body 130 includes a frame 110 in its upper part and a base substrate 120 in its lower part, which oppose each other. The frame 110 includes a side rail 111 which is an approximately rectangular frame and an operation substrate 113 surrounded by the side rail 111. The operation substrate 113 and the side rail 111 are connected by the rotation shaft 115, which has a narrow width, and thus the operation substrate 113 is supported on the rotation shaft 115 and vibrated about the axis C in the drawing. The deflecting reflection mirror 150 is approximately a trigonal prism and is supported on the operation substrate 113 and vibrates together with the operation substrate 113. A light source unit 11 faces the deflection mirror 150 and includes two light source units packaged in a pair. First and second light beams L₁ and L₂ exiting the light source unit 11 are reflected by the deflecting reflection mirror 150, which vibrates and reciprocates with a predetermined frequency to move in the main scanning direction. Deflecting reflection surfaces 150a and 150b are formed on the deflecting reflection mirror 150. More specifically, a first deflecting reflection surface 150a and a second deflecting reflection surface 150b corresponding to the first and second light beams L₁ and L₂ are formed with a predetermined angle therebetween. The deflecting reflection surfaces 150a and 150b are inclined with respect to the surface of the frame 110. That is, the first deflecting reflection surface 150a inclines when moving from the left end of the first deflecting reflection surface 150a to the boundary line 150c, and the second deflecting surface 150b declines when moving from the boundary line 150c to the right end of the second deflecting reflection surface 150b. The deflecting reflection mirror 150 has a substantially symmetric structure, and the first and second light beams L₁ and L₂ are directly emitted onto the deflecting reflection mirror 150. That is, the first and second light beams L₁ and L₂ are substantially perpendicular to the plane of the frame 110, and each of the deflecting reflection surfaces 150a and 150b has a common angle of incidence with respect to the incident light and reflects the first and second light beams L₁ and L₂ at a common angle of emission. The first and second light beams L₁ and L₂ are incident upon the deflecting reflection surfaces 150a and 150b with a predetermined beam pitch and are substantially parallel to each other. The first and second light beams L₁ and L₂ are reflected by the deflecting reflection surfaces 150a and 150b and proceed away from each other, and are scanned to the different photoreceptors (not shown). This process will be described in further detail later. The number of deflecting reflection surfaces is not limited to two but an optional number N of different deflecting reflection surfaces can be formed to correspond with the number N of light beams (N≧2).

The deflecting reflection mirror 150 is aligned to deflect two or more light beams emitted from the light source unit 11. For example, the deflecting reflection mirror 150 and the light source unit 11 are optically aligned so that the first and second light beams L₁ and L₂ are incident on the first and second deflecting reflection surfaces 150a and 150b. Although not shown, the beams are deflected in different directions by the first and second deflection reflecting surfaces 150a and 150b and pass through scanning optical lenses (not shown) disposed on each light path and are reflected by reflection mirrors (not shown) to the photoreceptors.

The frame 110 including the operation substrate 113 and the side rail 111 may be formed of a single-crystal silicon material to minimize the possibility of the rotation shaft 115 fracturing from fatigue caused by a repetitive torsional load. The deflecting reflection mirror 150 can be formed by providing a silicon trigonal prism, and then affixing the trigonal prism to the frame 110. Alternatively, the deflecting reflection mirror 150 can be formed in a single body with the frame 110, for example, by etching a silicon block with a predetermined thickness. The deflecting reflection surfaces 150a and 150b can be produced by glass treatment of the surface of the deflecting reflection mirror 150 with a silicon material, or by vapor deposition of a highly-reflective thin, metal layer such as aluminum or silver on the surface of the deflecting reflection mirror 150.

A driving conductive pattern 117 surrounds the deflecting reflection mirror 150 on the operation substrate 113. Specifically, the driving conductive pattern 117 is formed along the edge of the deflecting reflection mirror 150 in a loop shape. The driving conductive pattern 117 can be formed on the main surface of the operation substrate 113. An alternating current (AC) voltage whose polarity is periodically changed is applied to the driving conductive pattern 117 through a high voltage generator (not shown). As the voltage is applied to the driving conductive pattern 117, an induced magnetic field is generated around the deflecting reflection mirror 150. As the polarity of the applied voltage is reversed with high frequency, the polarity of the induced magnetic field is also reversed at the same cycle as the polarity of the voltage. The induced magnetic field provides driving power by interaction with permanent magnets 125, which will be described in detail later.

The frame 110 is supported on the base substrate 120, and the base substrate 120 is formed of an insulating material to insulate the frame 110 electrically. The base substrate 120 provides a predetermined space 120′ that is sized so that it does not interfere with the deflecting reflection mirror 150 as it vibrates. Permanent magnets 125 are disposed on the lower part of the predetermined space 120′. More specifically, the permanent magnets 125 are disposed near and facing both ends of the deflecting reflection mirror 150. The permanent magnets 125 may have opposite polarities. The permanent magnets 125 interact with the induced magnetic field generated by the driving conductive pattern 117, directing an attractive or repulsive force to the ends of the deflecting reflection mirror 150, and thus the deflecting reflection mirror 150 receives alternating torque and is rotated around the rotation shaft 115. Therefore, when the AC voltage whose polarity is periodically changed is applied to the driving conductive pattern 117, the deflecting reflection mirror 150 vibrates periodically as the polarity of the voltage which passes through the conductive pattern 117 changes. When a predetermined AC voltage corresponding to a resonance frequency of the deflecting reflection mirror 150 is applied, the deflecting reflection mirror 150 vibrates in resonance with a large vibration angle.

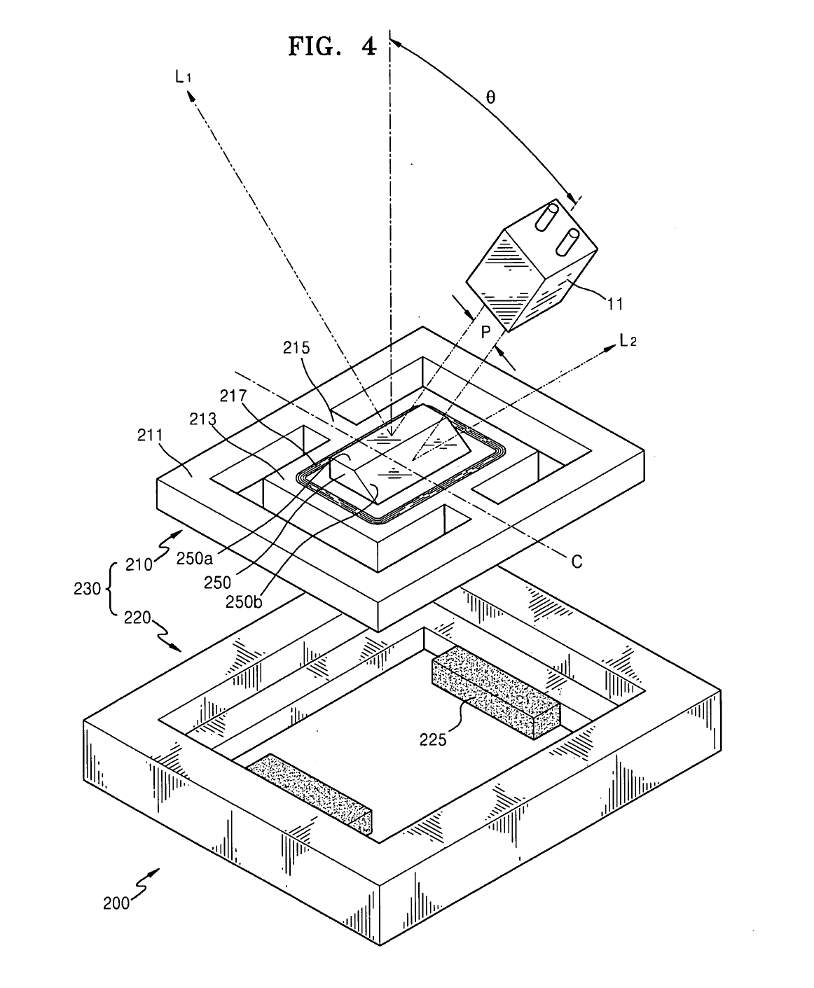

FIG. 4 illustrates a vibrating multi-beam deflector 200 according to a second exemplary embodiment of the present invention. Referring to FIG. 4, the beam deflector 200 includes a deflecting reflection mirror 250 and a driving body 230 that vibrates the deflecting reflection mirror 250. The driving body 230 includes a frame 210 and a base substrate 220 that face each other and are coupled to each other. The frame 210 includes a side rail 211 and an operation substrate 213 rotatably supported by the side rails 211. A deflecting reflection mirror 250 is formed on the operation substrate 213, which vibrates about the rotation shaft 215 with a high frequency. Deflecting reflection surfaces 250a and 250b form the surface of the deflecting reflection mirror 250 and scan the first and second light beams L₁ and L₂ in different directions. The first deflecting reflection surface 250a and the second deflecting reflection surface 250b have an asymmetric structure with respect to the surface of the frame 210. The first deflecting reflection surface 250a is horizontal with respect to the surface of the frame 210, and the second deflecting reflection surface 250b is inclined with respect to the surface of the frame 210 at an acute angle.

Since the deflecting reflection mirror 250 has an asymmetric structure, the light source unit 11 radiating light to the deflecting reflection mirror 250 can be disposed at an angle θ with respect to the normal of the surface of the frame 210. Accordingly, even though the first and second deflecting reflection surfaces 250a and 250b are asymmetric, the light beams L₁ and L₂ which are reflected by the first and second deflecting reflection surfaces 250a and 250b proceed symmetrically with respect to the normal of the surface of the frame 210. Thus, the entire scanning focusing optical system can have a symmetric optical arrangement, and the arrangement of each optical component can be simplified. This will be described in more detail later.

A driving conductive pattern 217 is formed on the operation substrate 213 to surround the deflecting reflection mirror 250 in a loop shape. A high frequency voltage generator (not shown) is connected to the ends of the conductive pattern 217. A current is supplied to the conductive pattern 217 and the conductive pattern 217 generates an induced magnetic field around the deflecting reflection mirror 250. The induced magnetic field interacts with a pair of permanent magnets 225 which are disposed to face both ends of the deflecting reflection mirror 250 inside the lower portion of the base substrate 220, providing alternating torque back and forth to the deflecting reflection mirror.

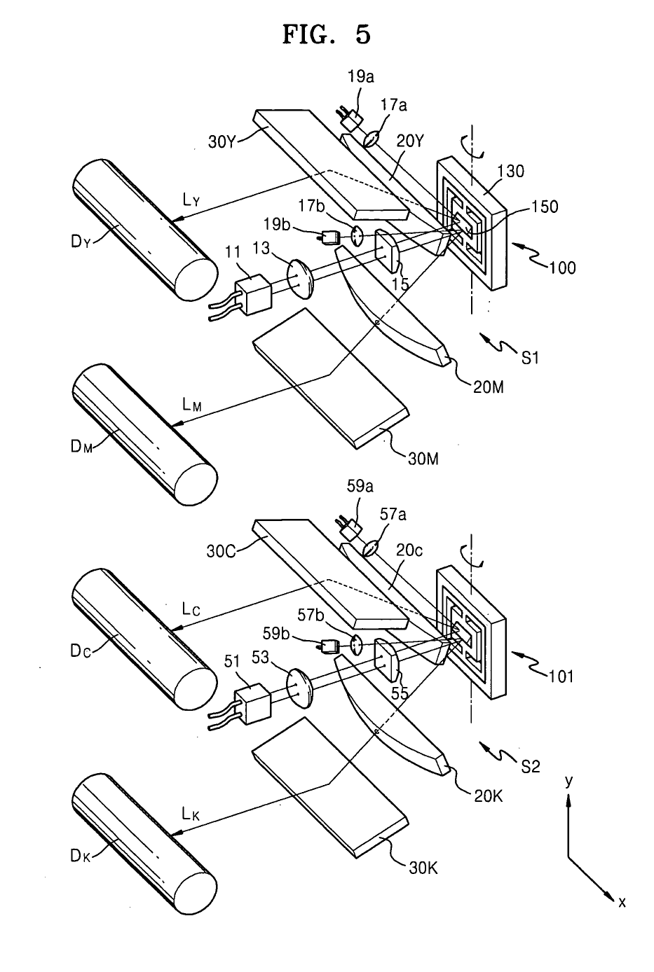

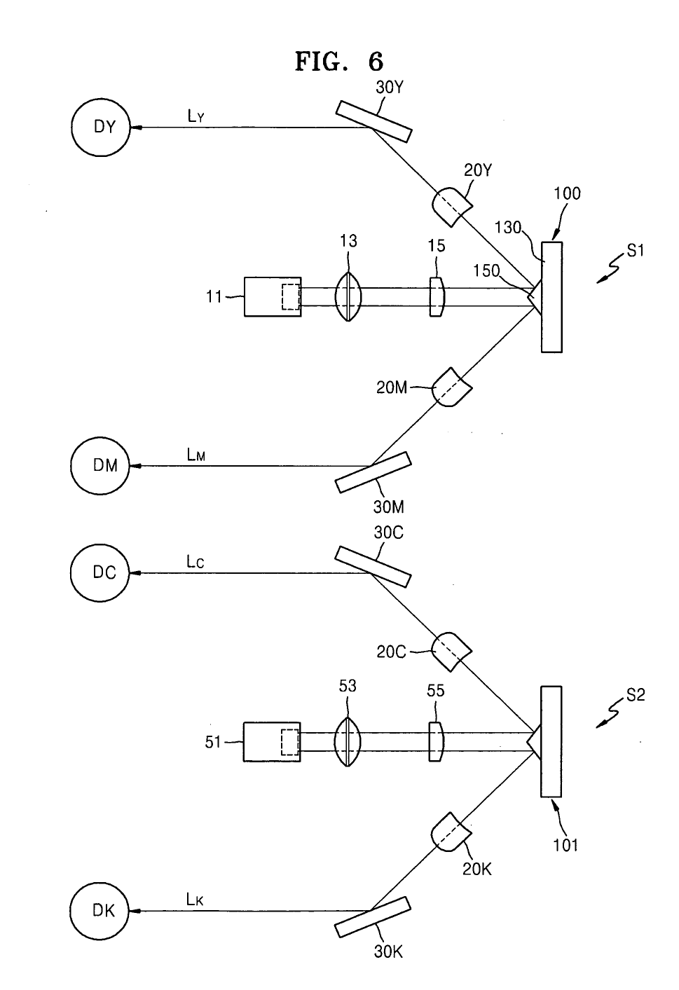

FIGS. 5 and 6 are a perspective view and a side view, respectively, of a multi-laser scanning unit according to a third exemplary embodiment of the present invention. In the illustrated multi-laser scanning unit, which can be applied to a color printer, light beams L_{Y}, L_{M}, L_{C}, and L_{K} exiting a light source unit 11 or 51 are deflected and scanned by abeam deflector 100 or 101 vibrating at a high frequency, and the scanned light beams L_{Y}, L_{M}, L_{C}, and L_{K} form latent images on first through fourth rotating photoreceptors D_{Y}, D_{M}, D_{C}, and D_{K}. In the present description, a main scanning direction refers to the direction along the rotational axis of the photoreceptors D_{Y}, D_{M}, D_{C}, and D_{K}, which is an x-direction in the present drawings. A sub-scanning direction refers to the direction of motion at this point on the surface of the rotating photoreceptors D_{Y}, D_{M}, D_{C}, and D_{K} where the scanned light beam L_{Y}, L_{M}, L_{C}, and L_{K} are incident, which is a y direction in the present drawings.

The first through fourth photoreceptors D_{Y}, D_{M}, D_{C}, and D_{K} may correspond to the four color components yellow, magenta, cyan, and black. As shown in the drawings, the first through fourth photoreceptors D_{Y}, D_{M}, D_{C}, and D_{K} are spaced apart from each other in the sub-scanning direction, that is, the y-direction. The multi-beam deflector of the present exemplary embodiment includes, corresponding to the photoreceptors D_{Y}, D_{M}, D_{C}, and D_{K} disposed in the sub-scanning direction, that is, the y direction, a first scanning focusing optical system S1 and a second scanning focusing optical system S2 disposed substantially parallel to each other in the sub-scanning direction. The first scanning focusing optical system S1 includes optical components for scanning the first and second light beams L_{Y} and L_{M} onto the first and second photoreceptors D_{Y} and D_{M}. The second scanning image formation optical system S2 is constructed to scan the third and fourth light beams L_{C} and L_{K} onto the third and fourth photoreceptors D_{C} and D_{K}.

In detail, the first scanning focusing optical system S1 includes the light source unit 11 which generates the first and second substantially parallel light beams L_{Y} and L_{M}, a beam deflector 100 scanning the first and second light beams L_{Y} and L_{M} for the photoreceptors D_{Y} and D_{M}, reflection mirrors 30Y and 30M for guiding the deflected light beams to the photoreceptors D_{Y} and D_{M}, and scanning optical lenses 20Y and 20M disposed between the beam deflector 100 and the reflection mirrors 30Y and 30M for focusing the light beam L_{Y} and L_{M} to form the latent images on the photoreceptors D_{Y} and D_{M}.

The light source unit 11 generates two or more different light beams L_{Y} and L_{M} which are substantially parallel to each other. For example, the light source unit can be laser diodes formed in a pair and packaged as identical optical components. The light source unit 11 emits light beams L_{Y} and L_{M} which are substantially parallel to each other toward the front surface of the beam deflector 100. A collimating lens 13 and a cylindrical lens 15 can be disposed on the light path between the light source unit and the beam deflector 100. The light beams L_{Y} and L_{M} are collimated by the collimating lens 13, and are focused and concentrated on the beam deflector 100 by the cylindrical lens 15.

The beam deflector 100 can have the structure shown in FIG. 3. In detail, the beam deflector 100 includes the deflecting reflection mirror 150, which vibrates at a high frequency. The first deflecting reflection surface 150a and the second deflecting reflection surface 150b are inclined symmetrically on the driving body 130, which provides a base surface. The first and second light beams L_{Y} and L_{M} are incident on their common beam deflector 100 and reflected in different directions by the first deflecting reflection surface 150a and the second deflecting reflection surface 150b, and thus form latent images on the photoreceptors D_{Y} and D_{M}. The first light beam L_{Y} deflected and scanned by the beam deflector 100 is incident on the first scanning optical lens 20Y. The first light beam L_{Y} that is deflected and scanned by the beam deflector 100 is incident on a first scanning lens 20Y, and the light path of the first light beam L_{Y} that is focused with different magnifications going in the main scanning direction is changed by the first reflection mirror 30Y, and the first light beam L_{Y} is focused on the first photoreceptor D_{Y}. The shape of the first scanning optical lens 20Y varies along a main scanning direction, and the incident light beam L_{Y} is focused with different magnifications on the photoreceptor D_{Y}.

Similarly, the second light beam L_{M}, which is scanned by the beam deflector 100, is incident on the second scanning optical lens 20M and is reflected by the second reflection mirror 30M onto the photoreceptor D_{M}. In the multi-scanning device of the present exemplary embodiment, each of the beam deflectors is used for the light beams exiting one of the light source units and scanned to different photoreceptors at the same time, thereby reducing the number of optical components of the multi-beam deflector and manufacturing costs. A detecting lens 17a and an optical sensor 19a are used to synchronize the position of a light spot formed on the first photoreceptor D_{Y} and image data for a latent image. Similarly, a detecting lens 17b and an optical sensor 19b are used to produce horizontally synchronized signals from the focusing position on the second photoreceptor D_{M}.

The second scanning focusing optical system S2 can have the same optical structure as the first scanning focusing optical system S1, and thus includes the light source unit 51 emitting the third and fourth light beams substantially parallel to each other, the second multi-beam deflector 101 which vibrates at a high frequency and deflects the light beams L_{C} and L_{K}, the third and fourth scanning optical lenses 20C and 20K which focus the third and fourth light beams L_{C} and L_{K} on the photoreceptors D_{C} and D_{K}, and the third and fourth reflection mirrors 30C and 30K that guide light beams L_{C} and L_{K} onto the photoreceptors D_{C} and D_{K}. The second scanning focusing optical system S2 is disposed in the same manner as the first scanning focusing optical system S1. That is, the surfaces of the first beam deflector 100 and the second beam deflector 101 on which light is incident are substantially parallel, the deflecting reflection surfaces are substantially parallel, and the light source units 11 or 51 are arranged to face the first beam deflector 100 and the second beam deflector 101 and are spaced apart from each other in the sub-scanning direction, that is, the y-direction. In addition, as in the first scanning focusing optical system S1, a collimating lens 53 and a cylindrical lens 55 can be disposed in a light path between the light source unit 51 and the beam deflector 101. Further, detecting lenses 57a and 57b for producing horizontally synchronized signals from the focusing position of the third and fourth photoreceptors D_{C} and D_{K} and optical sensors 59a and 59b can be installed in the exit path of light emitted from the beam deflector 101.

FIG. 5 illustrates first through fourth photoreceptors corresponding to four color components such as yellow, magenta, cyan, and black for color realization. However, the number or kind of photoreceptors can be selected according to which colors of ink are combined to realize a full color, and the present invention is not limited to the specific disclosed color. Furthermore, the technical features of the present invention can also be substantially applied to any selected photoreceptor. Accordingly, N photoreceptors (N≧2) can be placed in the first and second scanning focusing optical systems, and a corresponding number of light beams may exit the light source unit. The light beams are scanned to the corresponding photoreceptors by the multi-beam deflector having N deflecting reflection surfaces. For reference, when N photoreceptors are included in each scanning focusing optical system, then the entire beam deflector includes 2N photoreceptors, and full color realization is possible with 2N color components. These technical features are applicable in other exemplary embodiments described later.

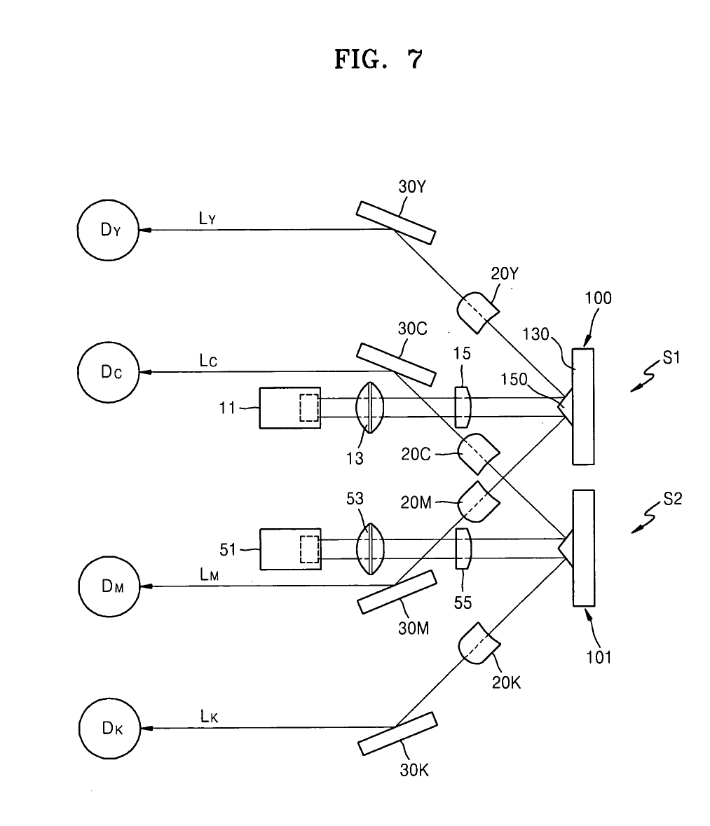

FIG. 7 is a side view of a laser scanning unit according to a fourth exemplary embodiment of the present invention. The multi-laser scanning unit of the present exemplary embodiment includes the same components as the multi-laser scanning unit shown in FIG. 6 except as described hereinafter. For better understanding, like reference numerals in the drawings denote like elements. Referring to FIG. 7, the first through fourth photoreceptors D_{Y}, D_{M}, D_{C}, and D_{K} corresponding to four color components such as yellow, magenta, cyan, and black are spaced apart from each other along a sub-scanning direction, and first and second scanning focusing optical systems S1 and S2 scan light beams onto the photoreceptors D_{Y}, D_{M}, D_{C}, and D_{K}. The first scanning focusing optical system S1 has a structure in which first and second light beams L_{Y} and L_{M} are scanned onto the photoreceptors D_{Y} and D_{M}. The second scanning focusing optical system S2 has a structure in which latent images are formed by scanning the third and fourth light beams L_{C} and L_{K} onto the photoreceptors D_{C} and D_{K}. Each of the scanning focusing optical systems S1 and S2 includes the light source unit 11 or 51 which generates and emits the light beams L_{Y}, L_{M}, L_{C}, and L_{K}, the beam deflector 100 or 101 which receives and deflects the light beams L_{Y}, L_{M}, L_{C}, and L_{K} from the light source unit 11 or 51 to scan them, and the scanning optical lenses 20Y, 20M, 20C, and 20K which focus the light beams L_{Y}, L_{M}, L_{C}, and L_{K} on the photoreceptors D_{Y}, D_{M}, D_{C}, and D_{K}. The first beam deflector 100 and the second beam deflector 101 are oriented with their deflecting reflection surfaces in the same direction so as to have the same incident direction, and the light source unit 11 or 51 faces the beam deflector 100 or 101.

The laser scanning unit of the present exemplary embodiment has a different arrangement than that shown in FIG. 6. In FIG. 6, the first scanning focusing optical system S1 and the second scanning focusing optical system S2 which are arranged in the sub-scanning direction are separated by a predetermined distance. However, the laser scanning unit of the present exemplary embodiment is placed such that the first scanning focusing optical system S1 and the second scanning focusing optical system S2 overlap each other in a predetermined range so that they are more compact. That is, the optical lens 20M and the reflection mirror 30M that are disposed in the lower portion of the first scanning focusing optical system S1 in the sub-scanning direction and the optical lens 20C and the reflection mirror 30C that are disposed in the upper portion of the second scanning focusing optical system S2 in the sub-scanning direction respectively overlap the second and first scanning focusing optical systems S2 and S1. Thus, the light path of the second light beam L_{M} which is guided by the first scanning focusing optical system S1 and the light path of the third light beam L_{C} which is guided by the second scanning focusing optical system S2 cross each other.

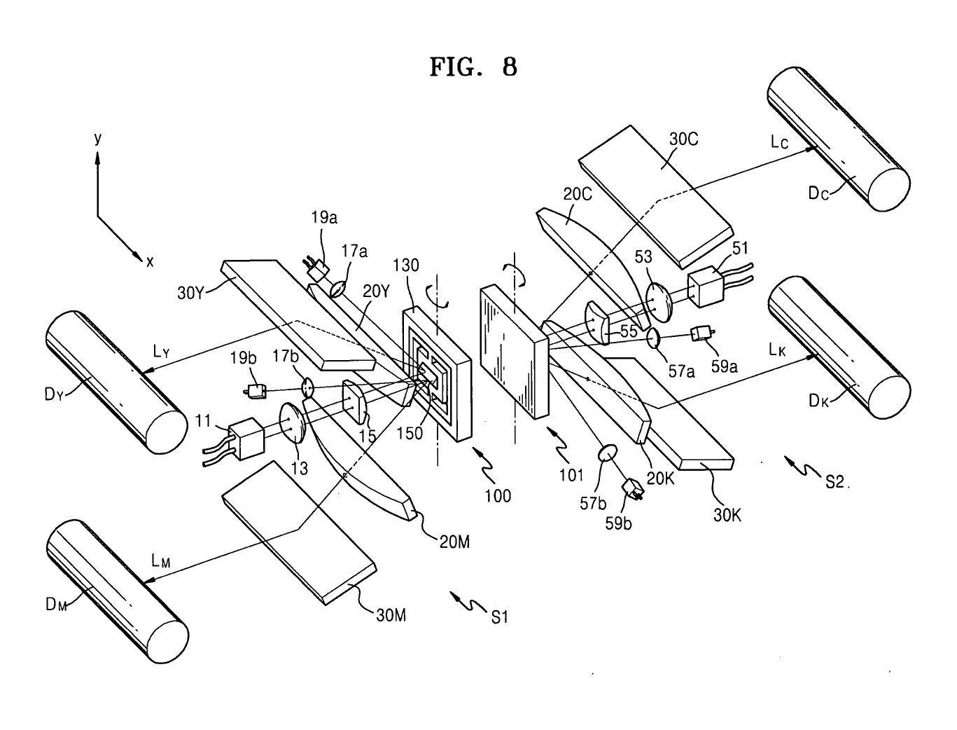

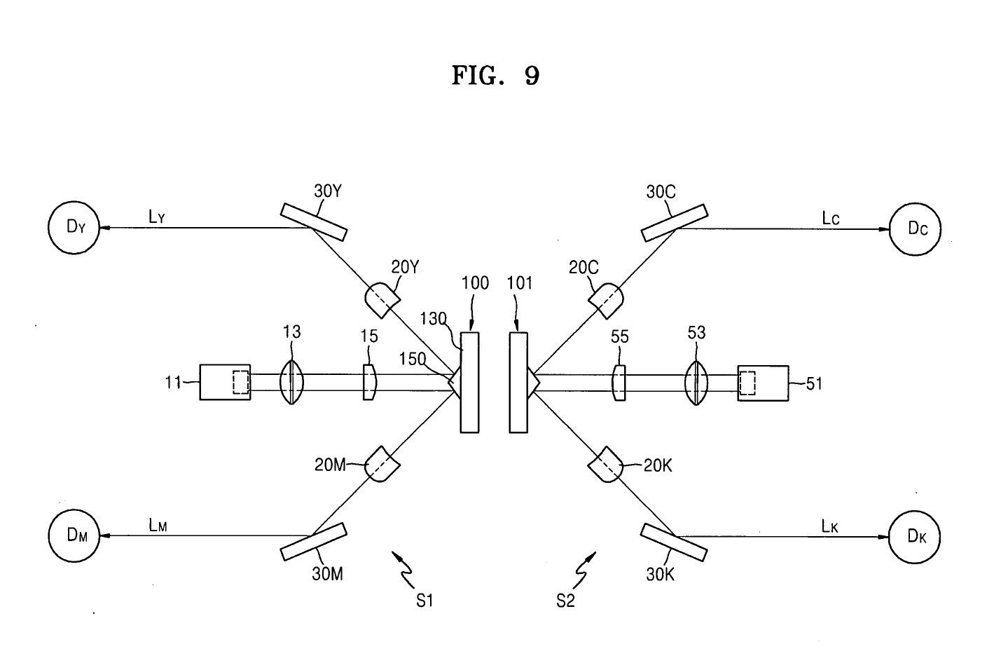

FIGS. 8 and 9 are, respectively, perspective and side views of a multi-laser scanning unit according to a fifth exemplary embodiment of the present invention. The multi-laser scanning unit of the present exemplary embodiment includes substantially the same components as the multi-laser scanning unit shown in FIG. 5, but the two have different technical features as described hereinafter. The first through fourth photoreceptors D_{Y}, D_{M}, D_{C}, and D_{K} corresponding to yellow, magenta, cyan, and black are placed in pairs on the left and right sides with respect to the beam deflectors 100 and 101. That is, the first and second photoreceptors D_{Y} and D_{M} are placed on one side of the beam deflectors 100 and 101 in the sub-scanning direction (y-direction), and the third and fourth photoreceptors D_{C} and D_{K} are placed on the opposite side of the beam deflectors 100 and 101 in the sub-scanning direction. Thus, the scanning focusing optical systems S1 and S2 form latent images on the photoreceptors D_{Y} and D_{M}, and the photoreceptors D_{C} and D_{K}, respectively. The first and second light beams L_{Y} and L_{M} are scanned by the first scanning focusing optical system S1 onto the first and second photoreceptors D_{Y} and D_{M}, and the third and fourth light beams L_{C} and L_{K} are scanned by the second scanning focusing optical system S2 onto the third and fourth photoreceptors D_{C} and D_{K}. More specifically, the first scanning focusing optical system S1 includes the first light source unit 11 which generates and radiates the first and second light beams L_{Y} and L_{M} substantially parallel to each other, the beam deflector 100 which receives the light beams L_{Y} and L_{M} and reflects the beams in different directions, the scanning optical lenses 20Y and 20M which focus the deflected light beams L_{Y} and L_{M} onto the corresponding photoreceptors, and the reflection mirrors 30Y and 30M. The beam deflector 100 can have the structure shown in FIG. 3. That is, the first deflecting reflection surface 150a and the second deflecting reflection surface 150b are formed on the deflecting reflection mirror 150 to reflect the first and second beams L_{Y} and L_{M}. The first and second deflecting reflection surfaces 150a and 150b scan the first and second light beams L_{Y} and L_{M} onto the first and second photoreceptors D_{Y} and D_{M} which are arranged along the sub-scanning direction.

The second focusing optical system S2 has a substantially identical structure to the first focusing optical system S1. More specifically, the second focusing optical system S2 includes the second light source unit 51 radiating the third and fourth light beams L_{C} and L_{K}, the beam deflector 101 receiving and deflecting the third and fourth light beams L_{C} and L_{K} radiated from the light source unit 51, the reflection mirrors 30C and 30K guiding the light beams L_{C} and L_{K} onto the photoreceptors D_{C} and D_{K}, and scanning optical lenses 20C and 20K which focus light beams to form the latent images on the photoreceptors D_{C} and D_{K}.

The multi-laser scanning unit of the present exemplary embodiment has a different arrangement than that shown in FIG. 5. In the first exemplary embodiment, the photoreceptors, D_{Y}, D_{M} D_{C}, and D_{K} are arranged substantially parallel to one another in the sub-scanning direction. More specifically, the first scanning focusing optical system S1 and the second scanning focusing optical system S2 reflect light in the same direction and are arranged along the sub-scanning direction. However, the multi-laser scanning unit of the present exemplary embodiment has an optical arrangement corresponding to a structure in which pairs of photoreceptors D_{Y} and D_{M}, and D_{C} and D_{K} in the sub-scanning direction are. arranged on the left and right sides. More specifically, the first scanning focusing optical system S1 and the second focusing optical system S2 reflect light in opposite directions. The differences in the optical arrangements will now be described.

The multi-laser scanning unit of FIG. 5 provides images to the photoreceptors D_{Y}, D_{M} D_{C}, and D_{K} arranged substantially parallel to one another along the sub-scanning direction. A light beam deflected by the beam deflector 100 or 101 scans a latent image onto the pair of the photoreceptors D_{Y} and D_{M}, and D_{C} and D_{K}. The first and second beam deflectors 100 and 101 are arranged such that the deflecting reflection surfaces 130a and 150b direct light in the same direction, and the first light source unit 11 and the second light source unit 51, which face the deflecting reflection surfaces, are arranged along the sub-scanning direction and emit substantially parallel light beams.

However, the multi-laser scanning unit illustrated in FIG. 8 provides images to the photoreceptors D_{Y}, D_{M}, D_{C}, and D_{K} which are arranged in pairs on opposite sides of the beam deflectors 100 and 101. The beam deflectors 100 and 101 scan light beams onto the photoreceptors D_{Y}, D_{M}, D_{C}, and D_{K} to form latent images. The first and second beam deflectors 100 and 101 are spaced apart by a predetermined distance so that the deflecting reflection surfaces 150a and 150b of the first and second beam deflectors 100 and 101 are directed in opposite directions. Accordingly, the first light source unit 11 and the second light source unit 51 emit light beams toward each other outside the beam deflectors 100 and 101.

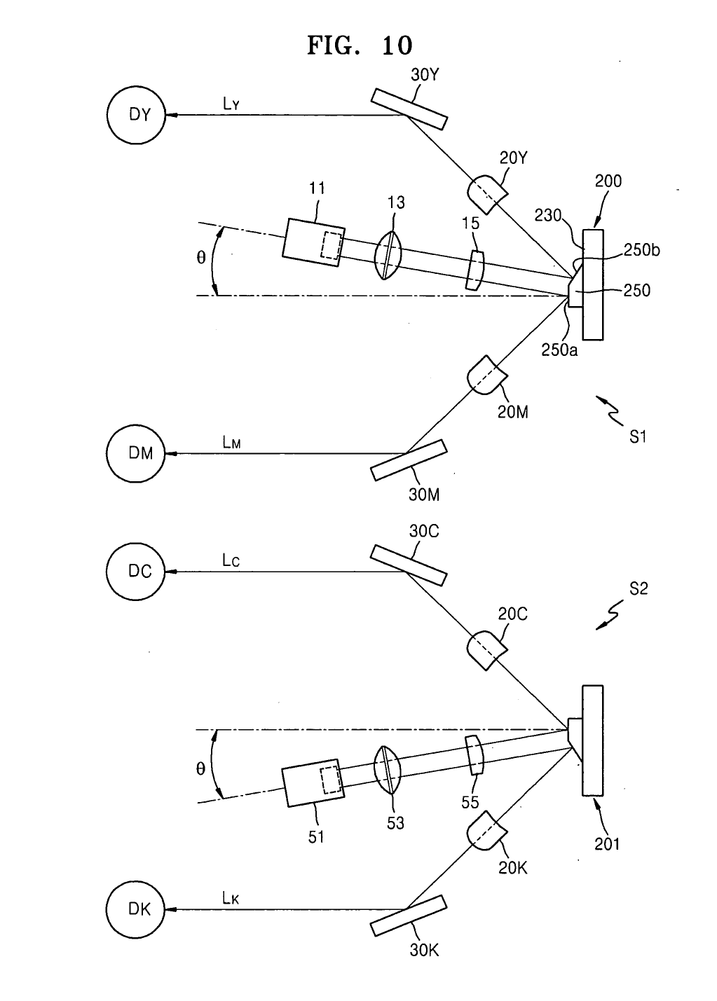

FIG. 10 is a side view of a multi-laser scanning unit according to a sixth exemplary embodiment of the present invention. The light beams L_{Y}, L_{M}, L_{C}, and L_{K} are radiated by the beam deflectors 200 and 201 onto the photoreceptors D_{Y}, D_{M}, D_{C}, and D_{K}, which are arranged along sub-scanning direction. The light beams scanned by the first beam deflector 200 and the second beam deflector 201 are focused on the photoreceptors arranged in the sub-scanning direction; the light beams scanned by the first and second beam deflectors 200 and 201 are focused on the photoreceptors arranged above and below the beam deflectors in the sub-scanning direction. The beam deflectors 200 and 201 have the structure shown in FIG. 4. Each of the beam deflectors 200 and 201 have first and second deflecting reflection surfaces 250a and 250b, which are angled with respect to each other by a predetermined angle and vibrate at a high frequency to scan different light beams. The two deflecting reflection surfaces 250a and 250b having an asymmetric structure are disposed on the planar substrate of the beam deflector 200. The first deflecting reflection surface 250a is substantially parallel to the surface of the driving body 230, and the second deflecting reflection surface 250b is angled relative to the driving body 230 by an acute angle. The beam deflector 200 vibrates with a predetermined frequency and deflects the light beams L_{Y} and L_{M} from the light source unit 11. The first deflecting reflection surface 250a scans the first light beam L_{Y}, and the second deflecting reflection surface 250b scans the second light beam L_{M} to the photoreceptors D_{Y} and D_{M}.

Since the beam deflector 200 or 201 according to an exemplary embodiment of the present invention has an asymmetric arrangement with the first deflecting reflection surface 250a substantially parallel to the driving body 230 and the second deflecting reflection surface 250a angled with respect to the surface of the driving body 230, the light source unit 11 can emit light at a predetermined angle 0 to the normal of the driving body 230.

Thus, despite the asymmetrically formed deflecting reflection surfaces 250a and 250b, the light beams L_{Y}, L_{M}, L_{C}, and L_{K} reflected by the deflecting reflection surfaces 250a and 250b are symmetrical about the vertical lines of the driving bodies 230. Accordingly, the overall optical arrangement of the focusing optical system can be symmetrical and the arrangement of each optical component can be simplified.

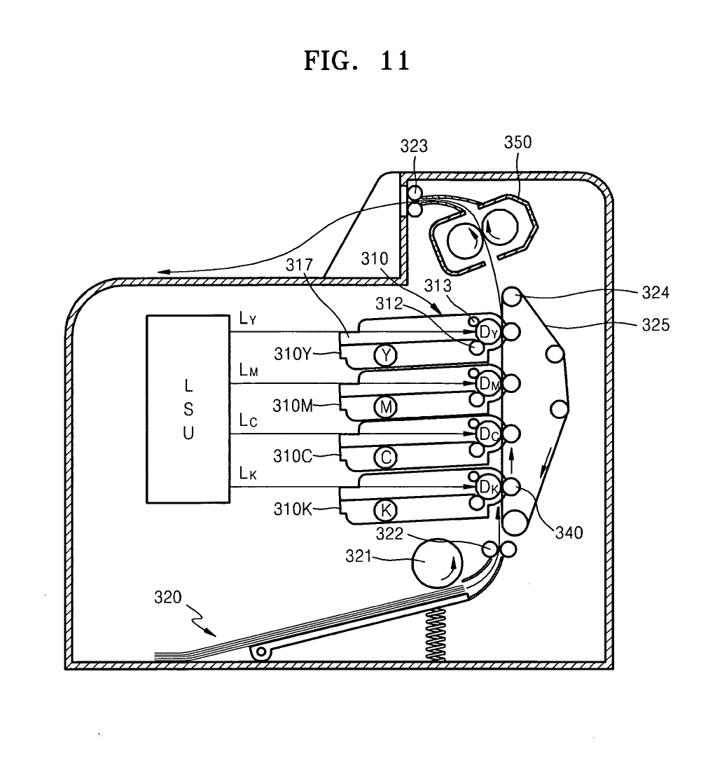

Referring to FIG. 11, an image forming apparatus according to an exemplary embodiment of the present invention comprises a developing unit 310, a conveying belt 325, a multi-laser scanning unit (LSU), transfer rollers 340 and a fuser 350. The developing unit 310 includes four developer cartridges 310Y, 310M, 310C and 310K that contain developer of different colors, for example, yellow (Y), magenta (M), cyan (C) and black (K), individually.

The conveying belt 325 circulates while being supported by a plurality of support rollers 324. The multi-laser scanning unit (LSU) scans light beams L_{Y}, L_{M}, L_{C}, and L_{K} corresponding to yellow (Y), magenta (M), cyan (C), and black (K) image data onto the photoreceptors D_{Y}, D_{M}, D_{C}, and D_{K} of the developer cartridges 310Y, 310M, 310C and 310K. The multi-laser scanning unit (LSU) may have the structure shown in FIG. 6. Alternatively, the multi-laser scanning unit (LSU) may have one of the structures shown in FIG. 7 or in FIG. 10.

Each of the developer cartridges 310Y, 310M, 310C and 310K includes a photoreceptor D_{Y}, D_{M}, D_{C}, and D_{K} and a developing roller 312. Each developer cartridge 310Y, 310M, 310C and 310K may further include an electrostatic charging roller 313. A charging bias voltage is applied to the electrostatic charging roller 313 so that the outer circumferences of the photoreceptors D_{Y}, D_{M}, D_{C}, and D_{K} are charged to a uniform electrostatic potential. Instead of the electrostatic charging roller 313, a corona discharger (not illustrated) can be used. The developing roller 312 provides toner to the photoreceptors D_{Y}, D_{M}, D_{C}, and D_{K} by adhering the toner to the outer circumferential surfaces of the photoreceptors. A developing bias is applied to the developing roller 312 to supply the toner to the photoreceptors D_{Y}, D_{M}, D_{C}, and D_{K}. Although not illustrated in the drawings, each of the developer cartridges 310Y, 310M, 310C and 310K may further include a supply roller that applies the toner to the developing roller 312, a regulating unit that regulates the quantity of toner applied to the developing roller 312, and an agitator that transfers toner contained therein to the supply roller and/or the developing roller 312. Each of the developer cartridges 310Y, 310M, 310C and 310K includes an opening 317 that forms a passage for light beams L_{Y}, L_{M}, L_{C}, and L_{K} from the multi-laser scanning unit (LSU) scanning the photoreceptors D_{Y}, D_{M}, D_{C}, and D_{K}. The outer circumferential surfaces of the photoreceptors D_{Y}, D_{M}, D_{C}, and D_{K} face the conveying belt 325.

The four transfer rollers 340 are arranged opposite the photoreceptors D_{Y}, D_{M}, D_{C}, and D_{K} of the developer cartridges 310Y, 310M, 310C and 310K with the conveying belt 325 between the transfer rollers 340 and the photoreceptors D_{Y}, D_{M}, D_{C}, and D_{K}. A transfer bias is applied to the transfer rollers 340.

The process of forming a color image with the above-described structure will now be described. The photoreceptors D_{Y}, D_{M}, D_{C}, and D_{K} of the developer cartridges 310Y, 310M, 310C and 310K are charged to a uniform electrostatic potential by applying a charging bias voltage to the electrostatic charging roller 313. The multi-laser scanning unit (LSU) forms an electrostatic latent image by radiating light beams L_{Y}, L_{M}, L_{C}, and L_{K} corresponding to yellow, magenta, cyan and black image data, respectively, onto the photoreceptors D_{Y}, D_{M}, D_{C}, and D_{K} of each developer cartridge 310Y, 310M, 310C and 310K through the opening 317. A developing bias voltage is applied to the developing roller 312. Then, toner on the outer circumference of the developing roller 312 adheres to the electrostatic latent image, and, consequently, toner images of yellow, magenta, cyan and black are formed on the photoreceptors D_{Y}, D_{M}, D_{C}, and D_{K} of the developer cartridge 310Y, 310M, 310C and 310K.

A sheet of print paper is picked up from cassette 320 by the pick-up roller 321. The sheet of print paper is put over the conveying belt 325 by the feed rollers 322. A front end of paper reaches the transfer nip about the same time as a front end of a black (K) toner image formed on the outer surface of the photoreceptor D_{K} of the developer cartridge 310K arrives at the transfer nip, facing the transfer roller 340. When a transfer bias voltage is applied to the transfer rollers 340, the toner images formed on the photoreceptor D_{K} are transferred to the sheet of print paper. As the sheet of print paper is fed; the cyan (C), magenta (M), and yellow (Y) toner images formed on the photoreceptors D_{C}, D_{M} and D_{Y} of the developer cartridges 310C, 310M and 310Y are sequentially transferred onto a sheet of print paper and are superimposed upon one another. Thus, a color toner image is formed on the sheet of print paper. The fuser 350 fixes the color toner image formed on the sheet of print paper by applying heat and pressure. The sheet of print paper to which the toner image has been fixed is discharged outside the image forming apparatus by discharging rollers 323.

The multi-beam deflector of the exemplary embodiments of the present invention deflects a plurality of light beams to scan the light beams onto the photoreceptors. Accordingly, compared to the prior art in which beam deflectors correspond to each photoreceptor, the number of light sources and optical components can be reduced for simplification of the apparatus, manufacturing costs of the multi-laser scanning unit can be lowered, and the degree of freedom of the arrangement of the optical components can be increased.

In particular, the multi-beam deflector of the exemplary embodiments of the present invention is formed in a relatively simple way, thereby making manufacturing easier and allowing a broader arrangement of components compared to the prior art. Thus, the arrangement of the components in the optical system can be simplified, manufacturing costs can be reduced, and high quality can be achieved.

Further, according to the exemplary embodiments of the present invention, since a plurality of light beams are scanned onto the photoreceptors corresponding to the color components, light scanning speed is increased compared to the prior art in which the photoreceptors are sequentially selected and scanned.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A multi-laser scanning unit which comprises first and second scanning focusing optical systems which each scan N light beams in a main scanning direction onto N photoreceptors proceeding in a sub-scanning direction to form a latent image, each of the scanning focusing optical systems comprising:
a light source unit radiating N light beams substantially parallel to each other, the light beams being spaced apart from each other by a beam pitch;
a multi-beam deflector comprising a deflecting reflection mirror comprising N deflecting reflection surfaces corresponding to the N photoreceptors with an angle between the deflecting reflection surfaces, the deflecting reflection surfaces scanning the light beams from the light source unit to the corresponding photoreceptors, and a driving body that vibrates the deflecting reflection mirror about a rotation axis; and
at least one focusing optical unit for focusing the light beams scanned from the multi-beam deflector onto each of the photoreceptors,
wherein the first scanning focusing optical system and the second scanning focusing optical system are arranged substantially parallel along a sub-scanning direction.

2. The multi-laser scanning unit of claim 1, wherein the driving body comprises:
a driving conductive pattern for forming an induced magnetic field around the deflecting reflecting mirror; and
a permanent magnet for providing driving power to the deflecting reflection mirror by interacting with the induced magnetic field.

3. The multi-laser scanning unit of claim 1, wherein the at least one focusing optical unit comprises:
scanning optical lenses for correcting light beams scanned by the multi-beam deflector with different magnifications along the main scanning direction and for focusing the beams on the corresponding photoreceptors; and
reflection mirrors disposed along the light paths exiting the scanning optical lenses for guiding the light beams to the corresponding photoreceptors.

4. The multi-laser scanning unit of claim 1, wherein the first scanning focusing optical system and the second scanning focusing optical system are spaced apart from each other along the sub-scanning direction.

5. The multi-laser scanning unit of claim 1, wherein portions of the first scanning focusing optical system and the second scanning focusing optical system overlap in the sub-scanning direction.

6. The multi-laser scanning unit of claim 1, wherein the photoreceptors are spaced apart from each other along the sub-scanning direction.

7. A multi-laser scanning unit which includes a first scanning focusing optical system and a second scanning focusing optical system which each form latent images by scanning two light beams in a main scanning direction onto first and second photoreceptors proceeding in a sub-scanning direction, each of the scanning focusing optical systems comprising:
a light source unit emitting two different light beams substantially parallel to each other, the light beams being spaced apart from each other by a beam pitch;
a multi-beam deflector comprising a deflecting reflection mirror comprising first and second deflecting reflection surfaces corresponding to the first and second photoreceptors, the first and second deflecting reflection surfaces being angled with respect to one another and scanning the light beams from the light source unit onto the corresponding photoreceptors, and a driving body for vibrating the deflecting reflection mirror about a rotation axis;
a scanning optical lens for correcting each light beam scanned from the multi-beam deflector with different magnifications in a main scanning direction and for focusing the light beam on each photoreceptor;
a reflection mirror disposed in the exit path of the scanning optical lens, the reflection mirror guiding light onto each of the photoreceptors,
wherein the first scanning focusing optical system and the second scanning focusing optical system are arranged substantially parallel to each other along a sub-scanning direction.

8. The multi-laser scanning unit of claim 7, wherein the first deflecting reflection surface and the second deflecting reflection surface are inclined symmetrically on the installation surface of the driving body.

9. The multi-laser scanning unit of claim 8, wherein the light source unit faces the deflecting reflection mirror so that the light beams are incident upon a front surface of the deflecting reflection mirror.

10. The multi-laser scanning unit of claim 7, wherein the first deflecting reflection surface is substantially parallel with respect to the surface of the driving body and the second deflecting reflection surface is inclined with respect to the surface of the driving body.

11. The multi-laser scanning unit of claim 10, wherein the second deflecting reflection surface forms an acute angle with respect to the surface of the driving body.

12. The multi-laser scanning unit of claim 11, wherein the light source unit faces the deflecting reflection mirror at an angle with respect to the normal of the surface of the driving body.

13. A multi-laser scanning unit which includes a first scanning focusing optical system and a second scanning focusing optical system which each form latent images by scanning N light beams in a main scanning direction onto N photoreceptors spaced along a sub-scanning direction, each of the scanning focusing optical systems comprising:
a light source unit radiating the N light beams substantially parallel to each other, the light beams being spaced apart by a beam pitch;
a multi-beam deflector comprising a deflecting reflection mirror comprising N deflecting reflection surfaces corresponding to the N photoreceptors, the deflecting reflection surfaces forming an angle with respect to each other, the deflecting reflection surfaces scanning the light beams from the light source unit to the corresponding photoreceptors, and a driving body for vibrating the deflecting reflection mirror about a rotation axis; and
at least one focusing optical unit for focusing the light beams scanned from the multi-beam deflector,
wherein the first scanning focusing optical system and the second scanning focusing optical system are arranged at the same level along the sub-scanning direction.

14. The multi laser scanning unit of claim 13, wherein the photoreceptors, to which light beams are scanned by an identical scanning focusing optical system of one of the first scanning focusing optical system or the second scanning focusing optical system, are separated from each other along a sub-scanning direction.

15. A multi-laser scanning unit which includes a first scanning focusing optical system and a second scanning focusing optical system which form a latent image by scanning two different light beams in a main scanning direction onto two different photoreceptors proceeding in a sub-scanning direction, each scanning focusing optical system comprising:
a light source unit including two different light sources and radiating two different light beams substantially parallel to each other, the light beams being spaced apart by a beam pitch;
a vibrating multi-beam deflector comprising a deflecting reflection mirror including a first deflecting reflection surface and a second deflecting reflection surface that correspond to each of the photoreceptors, the first and second deflecting reflection surfaces being at an angle with respect to each other, and a driving body for vibrating the deflecting reflection mirror about a rotation axis;
scanning optical lenses for correcting each light beam scanned from the multi-beam deflector with different magnifications along the main scanning direction and focusing on each photoreceptor; and
reflection mirrors placed on the light exit path of the scanning optical lens and guiding light onto each photoreceptor,
wherein the first scanning focusing optical system and the second scanning focusing optical system are arranged at the same level along a sub-scanning direction.

16. An image forming apparatus comprising:
a multi-laser scanning unit comprising first and second scanning focusing optical systems which each scan N light beams in a main scanning direction onto N photoreceptors proceeding in a sub-scanning direction to form a latent image, the first and second scanning focusing optical system being arranged substantially parallel along a sub-scanning direction; and
a developing unit for developing the latent images formed on the photoreceptors into a visible image on a printing medium,
wherein each of the scanning focusing optical systems comprises:
a light source unit radiating the N light beams substantially parallel to each other, the light beams being spaced apart from each other by a beam pitch;
a multi-beam deflector comprising a deflecting reflection mirror having N deflecting reflection surfaces corresponding to the N photoreceptors with an angle between the deflecting reflection surfaces, the deflecting reflection surfaces scanning the light beams from the light source unit to the corresponding photoreceptors, and a driving body that vibrates the deflecting reflection mirror about a rotation axis; and
at least one focusing optical unit for focusing the light beams scanned from the multi-beam deflector onto each of the photoreceptors.

17. The image forming apparatus of claim 16, wherein the first scanning focusing optical system and the second scanning focusing optical system are spaced apart from each other along the sub-scanning direction.

18. The image forming apparatus of claim 16, wherein portions of the first scanning focusing optical system and the second scanning focusing optical system overlap in the sub-scanning direction.

19. An image forming apparatus with a multi-laser scanning unit comprising a first scanning focusing optical system and a second scanning focusing optical system which each form latent images by scanning two light beams in a main scanning direction onto first and second photoreceptors proceeding in a sub-scanning direction, each of the scanning focusing optical systems comprising:
a light source unit emitting two different light beams substantially parallel to each other, the light beams being spaced apart from each other by a beam pitch;
a multi-beam deflector comprising a deflecting reflection mirror comprising first and second deflecting reflection surfaces corresponding to the first and second photoreceptors, the first and second deflecting reflection surfaces being angled with respect to one another and scanning the light beams from the light source unit onto the corresponding photoreceptors, and a driving body for vibrating the deflecting reflection mirror about a rotation axis;
a scanning optical lens for correcting each light beam scanned from the multi-beam deflector with different magnifications in a main scanning direction and for focusing the light beam on each photoreceptor;
a reflection mirror disposed in the exit path of the scanning optical lens, the reflection mirror guiding light onto each of the photoreceptors,
wherein the first scanning focusing optical system and the second scanning focusing optical system are arranged substantially parallel to each other along a sub-scanning direction.

20. An image forming apparatus with a multi-laser scanning unit comprising a first scanning focusing optical system and a second scanning focusing optical system which each form latent images by scanning N light beams in a main scanning direction onto N photoreceptors spaced along a sub-scanning direction, each of the scanning focusing optical systems comprising:
a light source unit radiating the N light beams substantially parallel to each other, the light beams being spaced apart by a beam pitch;
a multi-beam deflector comprising a deflecting reflection mirror comprising N deflecting reflection surfaces corresponding to the N photoreceptors, the deflecting reflection surfaces forming an angle with respect to each other, the deflecting reflection surfaces scanning the light beams from the light source unit to the corresponding photoreceptors, and a driving body for vibrating the deflecting reflection mirror about a rotation axis; and
at least one focusing optical unit for focusing the light beams scanned from the multi-beam deflector,
wherein the first scanning focusing optical system and the second scanning focusing optical system are arranged at the same level along the sub-scanning direction.

21. The image forming apparatus of claim 20, wherein the photoreceptors, to which light beams are scanned by an identical scanning focusing optical system of one of the first scanning focusing optical system or the second scanning focusing optical system, are separated from each other along a sub-scanning direction.

22. An image forming apparatus with a multi-laser scanning unit comprising a first scanning focusing optical system and a second scanning focusing optical system which form a latent image by scanning two different light beams in a main scanning direction onto two different photoreceptors proceeding in a sub-scanning direction, each scanning focusing optical system comprising:
a light source unit including two different light sources and radiating two different light beams substantially parallel to each other, the light beams being spaced apart by a beam pitch;
a vibrating multi-beam deflector comprising a deflecting reflection mirror including a first deflecting reflection surface and a second deflecting reflection surface that correspond to each of the photoreceptors, the first and second deflecting reflection surfaces being at an angle with respect to each other, and a driving body for vibrating the deflecting reflection mirror about a rotation axis;
scanning optical lenses for correcting each light beam scanned from the multi-beam deflector with different magnifications along the main scanning direction and focusing on each photoreceptor; and
reflection mirrors placed on the light exit path of the scanning optical lens and guiding light onto each photoreceptor,
wherein the first scanning focusing optical system and the second scanning focusing optical system are arranged at the same level along a sub-scanning direction.
